(19) United States
(12) Patent Application Publication
(10) Pub. No.: US 2025/0146348 A1
(43) Pub. Date: May 8, 2025

(54) SIDE SLIDING DOOR

(71) Applicant: GUOCHUANG INNOVATION CENTER OF MOBILE ENERGY (JIANGSU) CO., LTD., Jiangsu (CN)

(72) Inventors: Bo Jiang, Jiangsu (CN); Chengfei Zhang, Jiangsu (CN); Longlong Chen, Jiangsu (CN); Lixiong Xu, Jiangsu (CN)

(73) Assignee: GUOCHUANG INNOVATION CENTER OF MOBILE ENERGY (JIANGSU) CO., LTD., Jiangsu (CN)

(21) Appl. No.: 18/867,009

(22) PCT Filed: Jun. 16, 2023
(86) PCT No.: PCT/CN2023/100667

§ 371 Date: Nov. 19, 2024

(30) Foreign Application Priority Data
Jun. 24, 2022 (CN) 202221625707.8

(51) Int. Cl. E05F 15/643

(52) U.S. Cl. CPC E05F 15/643; E05Y 2201/668; E05Y 2201/672; E05Y 2201/684; E05Y 2201/686

(57) ABSTRACT

A side sliding door includes: a door panel; a door frame; a transmission assembly, including two sets of synchronous tape modules, the two sets of synchronous tape modules being arranged in parallel one above the other on the door frame; a synchronous drive module, the synchronous motion of the two sets of synchronous tape modules driving the door panel to perform a flat opening action in the horizontal direction. The synchronous tape modules each include a driving belt wheel, a driven belt wheel and a synchronous belt; the synchronous drive module includes a drive member, a driving shaft and a driven shaft; the two ends of the driving shaft are respectively connected to the two driving belt wheels, the two ends of the driven shaft are respectively connected to the two driven belt wheels, and the drive member drives the driving shaft to rotate.

### TECHNICAL FIELD

The disclosure relates to the field of charging equipment technology, specifically to a side sliding door.

### DESCRIPTION OF RELATED ART

Currently, various automatic charging equipment for the new energy special transportation field are becoming increasingly common, with side automatic charging mode being one of the main types, where the charging arm charges the new energy special vehicle from its side. Since most of these side automatic charging equipment are situated in relatively harsh environments, such as mines and steel plants, which are typical operating scenarios with a lot of dust, sand, and gravel, the primary requirement for side automatic charging equipment is to design an electric door system that may achieve automatic opening and closing.

Currently, some side automatic charging equipment are not equipped with an automatic opening and closing electric door system, but simply have a fixed retractable opening for the mechanical arm to enter and exit, which belongs to a category with poor protection level and automation level. Others are equipped with a simple automatic opening and closing electric door system, which may lift the electric door upwards or have a dual-opening electric door. As recorded in the document with application number CN202110653143.2, it describes an automatic docking charging device, where a housing is set outside the bracket, the housing has an opening, a cover plate is hinged to the bracket through a linkage assembly, a lifting cylinder is hinged to the bracket, the output end of the lifting cylinder is hinged to the linkage assembly, and the lifting cylinder drives the cover plate to rise to open the opening or descend to cover the opening. The linkage assembly includes a set of parallel connecting rods and support rods, one end of the connecting rod is hinged to the bracket, and the other end is hinged to the cover plate, the support rod is hinged between the two connecting rods and parallel to the cover plate. There are two sets of linkage assemblies, set on both sides of the bracket, and connected by a crossbar. The aforementioned housing cover plate may automatically open, facilitating the charging assembly inside the housing to extend out and dock with the power receiving box for charging, but the up and down movement of the cover plate requires space both above and horizontally, increasing the overall height of the equipment. An excessively high overall height is very likely to interfere with the vehicle body, causing obstacles to automatic charging. In addition, it also increases the distance between the charging end and the receiving end, enlarging the telescopic motion stroke of the charging end, which is not conducive to the miniaturization of the structure.

### SUMMARY

To solve the technical problem in the existing technology where lifting electric doors and dual-opening electric doors occupy a large space, resulting in large equipment volume and frequent interference causing obstacles to automatic charging, the present disclosure provides a side sliding door, which solves the aforementioned technical problem. The technical solution of the present disclosure is as follows:

A side sliding door includes:
A door panel;
A door frame;

A transmission assembly, wherein the transmission assembly includes two sets of synchronous tape modules, the two sets of synchronous tape modules are arranged in parallel one above the other on the door frame;

A synchronous drive module, driving the two sets of synchronous tape modules to move synchronously, and the synchronous motion of the two sets of synchronous tape modules driving the door panel to perform a flat opening action in the horizontal direction.

The side sliding door of the present disclosure, through the configuration of two sets of synchronous tape modules, with the two sets of synchronous tape modules arranged in parallel one above the other, may drive the door panel to perform a flat opening action in the horizontal direction, thus it will not increase the overall height of the charging equipment, and consequently will not cause obstacles to automatic charging due to interference. The door panel performs a flat opening action, requiring no movement space, thus it will not increase the distance between the charging end and the receiving end, and will not increase the telescopic movement stroke of the charging end, enabling the miniaturization of the structure. Moreover, the synchronous drive of the two sets of synchronous tape modules ensures that the resultant driving force for opening and closing the door panel is located at the center position of the door panel, ensuring a stable driving effect on the door panel.

According to an embodiment of the present disclosure, the synchronous tape module includes a driving belt wheel, a driven belt wheel and a synchronous belt. The synchronous drive module includes a drive member, a driving shaft and a driven shaft. The driving shaft and the driven shaft are both rotatably assembled, the two ends of the driving shaft are connected with two driving belt wheels respectively, the two ends of the driven shaft are connected with two driven belt wheels respectively, and the drive member drives the driving shaft to rotate.

According to an embodiment of the present disclosure, the axial middle portion of the driving shaft is assembled with a transmission wheel, the drive member drives the transmission wheel to rotate through a driving belt.

According to an embodiment of the present disclosure, a guide rod is further included. The guide rod is configured for the synchronous tape module. The guide rod is parallel to the synchronous tape module. The synchronous tape module is connected to the door panel through a connecting assembly. The connecting assembly moves along the guide rod when being driven by the synchronous tape module.

According to an embodiment of the present disclosure, the connecting assembly includes a first fixing base, a linear bearing and a second fixing base. The first fixing base moves with the synchronous belt, the first fixing base drives the linear bearing to move linearly along the guide rod, and the linear bearing drives the door panel to move through the second fixing base.

According to an embodiment of the present disclosure, the door panel is slidably assembled on the second fixing base through an adapter base. The sliding direction of the adapter base relative to the second fixing base is perpendicular to the extending direction of the guide rod.

According to an embodiment of the present disclosure, a track is formed on the door frame. The adapter base is formed with a sliding portion. The sliding portion extends into the track and moves along the track.

According to an embodiment of the present disclosure, an elastic member is also disposed between the adapter base and the second fixing base. Under the action of the elastic member, the sliding portion may maintain abutted against the inner wall surface of the track.

According to an embodiment of the present disclosure, the inner wall surface of the track includes a straight line segment and a curve segment. The straight line segment is parallel to the axis of the guide rod, and the curve segment bends towards the guide rod.

According to an embodiment of the present disclosure, a tension assembly is further included. The tension assembly is configured for the synchronous tape module, and the tension assembly tensions the synchronous belt.

Based on the above technical solution, the technical effects that may be achieved by the present disclosure are as follows.

The side sliding door of the present disclosure, through the arrangement of two sets of synchronous belts, with the two sets of synchronous belts arranged in parallel one above the other, may drive the door panel to perform a flat opening action in the horizontal direction, thus it will not increase the overall height of the charging equipment, and consequently will not cause automatic charging obstacles due to interference. The door panel performs a flat opening action, requiring no movement space, thus it will not increase the distance between the charging end and the receiving end, and will not increase the telescopic movement stroke of the charging end, enabling the miniaturization of the structure. Moreover, the synchronous drive of the two sets of synchronous belts makes the resultant driving force for opening and closing the door panel located at the center position of the door panel, thus ensuring a stable driving effect on the door panel.

The side sliding door of the present disclosure sets up a synchronous drive module including a drive member, a driving shaft and a driven shaft. The driving shaft ensures synchronous operation of the driving belt wheels of the two sets of synchronous tape modules, the driven shaft ensures synchronous operation of the driven belt wheels of the two sets of synchronous tape modules, thus realizing synchronous operation of the synchronous tape modules. Moreover, a transmission wheel is assembled at the axial middle portion of the driving shaft. The drive member drives the transmission wheel, that is, the drive member drives the driving shaft from the axial middle portion of the driving shaft, thus ensuring synchronous drive of the two sets of synchronous tape modules.

The side sliding door of the present disclosure sets up a guide rod, which may define the synchronous tape module to drive the door panel to move linearly along the guide rod. Specifically, the present disclosure sets up the structure of the connecting assembly, which may ensure the cooperative relationship between the door panel and the synchronous belt, and the guide rod. The present disclosure further sets up the door panel to be slidably assembled on the second fixing base through an adapter base, thus the door panel may realize sliding parallel to the direction of the guide rod and sliding perpendicular to the direction of the guide rod. In combination with the track on the door frame, when the sliding portion of the adapter base moves in the straight line segment of the track, the door panel may perform horizontal translational movement. When the sliding portion of the adapter base moves in the curve line segment of the track, the door panel may perform an inward movement relative to the opening of the door frame, with the door panel embedded into the opening of the door frame; or the door panel may perform an outward movement relative to the opening of the door frame, with the door panel pushed out of the opening of the door frame.

In the side sliding door of the present disclosure, an elastic member is disposed between the adapter base and the second fixing base, under the pulling force of the elastic member, the sliding portion of the adapter base may always be pulled tight against the inner wall surface of the track.

### BRIEF DESCRIPTION OF THE DRAWINGS

FIG. 1 is a structural schematic view of a front side of the side sliding door of the present disclosure.

FIG. 2 is a structural schematic view of a rear side of the side sliding door.

FIG. 3 is a structural schematic view of a rear side of the side sliding door with the door panel removed.

FIG. 4 is a structural schematic view of the synchronous drive module and transmission assembly in cooperation.

FIG. 5 is a structural schematic view of the connecting assembly in cooperation with the synchronous belt, the guide rod, and the track.

FIG. 6 is a schematic view of the connecting assembly in cooperation with the position-limiting switch.

FIG. 7 is a structural schematic view of the connecting assembly.

FIG. 8 is an exploded view of the connecting assembly.

FIG. 9 is a structural schematic view of the second fixing base.

FIG. 10 is a schematic view of the curve showing the change in the inner wall surface of the track.

FIG. 11 is a state diagram of the door panel of the side sliding door in an open state.

In the figures: 1—door panel; 11—sealing strip; 2—door frame; 21—bearing base; 22—mounting base; 23—track; 3—synchronous tape module; 31—driving belt wheel; 32—driven belt wheel; 33—synchronous belt; 4—synchronous drive module; 41—driving shaft; 411—first driving shaft; 412—second driving shaft; 413—coupling; 42—driven shaft; 43—transmission wheel; 5—guide rod; 6—connecting assembly; 61—first fixing base; 611—fixing hole; 62—linear bearing; 621—side panel; 622—roller; 63—second fixing base; 631—slide rail; 64—adapter base; 641—sliding portion; 642—slider; 65—sensing member; 66—elastic member; 7—tension assembly; 71—tension idler; 72—tension belt wheel; 8—position-limiting switch; 81—rolling wheel.

### DESCRIPTION OF THE EMBODIMENTS

The following description will clearly and completely describe the technical solutions in the embodiments of the present disclosure in conjunction with the accompanying drawings of the embodiments of the present disclosure. Clearly, the described embodiments are only a portion of the embodiments of the present disclosure, not based on the overall embodiments in the present disclosure. The description herein after at least one example embodiment is purely illustrative and shall not be construed as limiting the scope of the present disclosure or its application or use in any manner. Based on the embodiments disclosed in the present disclosure, all other embodiments obtained by those skilled in the art without creative effort fall within the scope of protection of the present disclosure.

It should be noted that the terms used here are only for describing specific implementation methods, and are not intended to limit the example embodiments according to the disclosure. As used herein, unless explicitly stated otherwise by the context, singular forms are also intended to include plural forms. Furthermore, it should be understood that when the terms “include” and/or “comprise” are used in this specification, they indicate the presence of features, steps, operations, assemblies, and/or combinations thereof.

Unless otherwise specifically stated, the relative arrangement, numerical expressions, and values of the assemblies and steps described in these embodiments do not limit the scope of the present disclosure. In the meantime, it should be understood that, for the convenience of description, the dimensions of various portions shown in the drawings are not drawn according to the actual proportional relationship. For technologies, methods, and equipment known to those skilled in the relevant field, detailed discussions may not be made, but in appropriate circumstances, the said technologies, methods, and equipment should be regarded as portion of the specification. In all examples shown and discussed here, any specific values should be interpreted as merely exemplary and not as limitations. Therefore, other examples of exemplary embodiments may have different values. It should be noted that: similar numerals and letters in the following drawings indicate similar items, so once an item is defined in one drawing, it does not need to be further discussed in subsequent drawings.

In the description of the present disclosure, it should be understood that directional terms such as “front, back, up, down, left, right”, “lateral, vertical, perpendicular, horizontal” and “top, bottom” and other directional or positional relationships indicated are usually based on the orientation or positional relationship shown in the drawings, and are only for the convenience of describing the present disclosure and simplifying the description. In the absence of contrary statements, these directional terms do not indicate or imply that the referred device or element must have a specific orientation or be constructed and operated in a specific orientation, and therefore cannot be understood as a limitation on the scope of protection of the present disclosure; the directional terms “inner, outer” refer to the inside and outside of the contour of the assemblies themselves.

For the convenience of description, spatial relative terms may be used here, such as “on . . . ”, “above . . . ”, “on the surface of . . . ”, “over” etc., to describe the spatial relationship between one assembly or feature and other assemblies or features as shown in the figures. It should be understood that the spatial relative terms are intended to encompass different orientations of the device in use or operation in addition to the orientation depicted in the figures. For example, if the device in the figure is inverted, then the device described as “above other devices or structures” or “on other devices or structures” will be positioned “below other devices or structures” or “under other devices or structures”. Thus, the example term “above . . . ” may include both “above . . . ” and “below . . . ” orientations. The device may also be positioned in other different ways (rotated 90 degrees or in other orientations), and the spatial relative descriptions used here may be interpreted accordingly.

In addition, it should be noted that the use of words such as “first”, “second” to define assemblies is merely for the convenience of distinguishing the corresponding assemblies. Unless otherwise stated, these words have no special meaning and therefore cannot be understood as a limitation on the scope to be protected by the present disclosure.

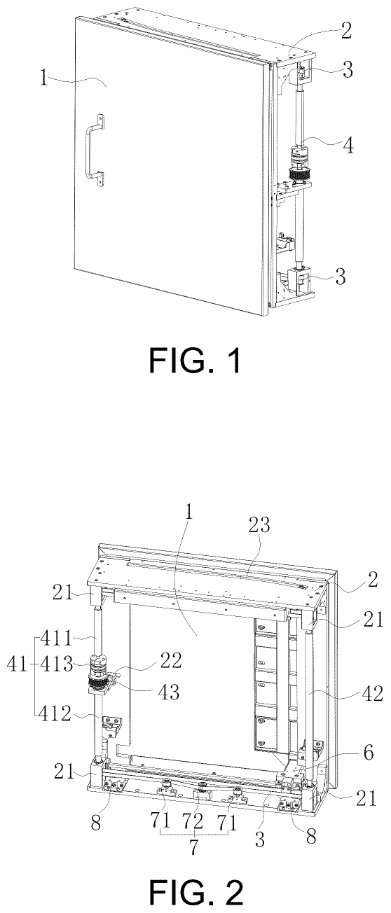

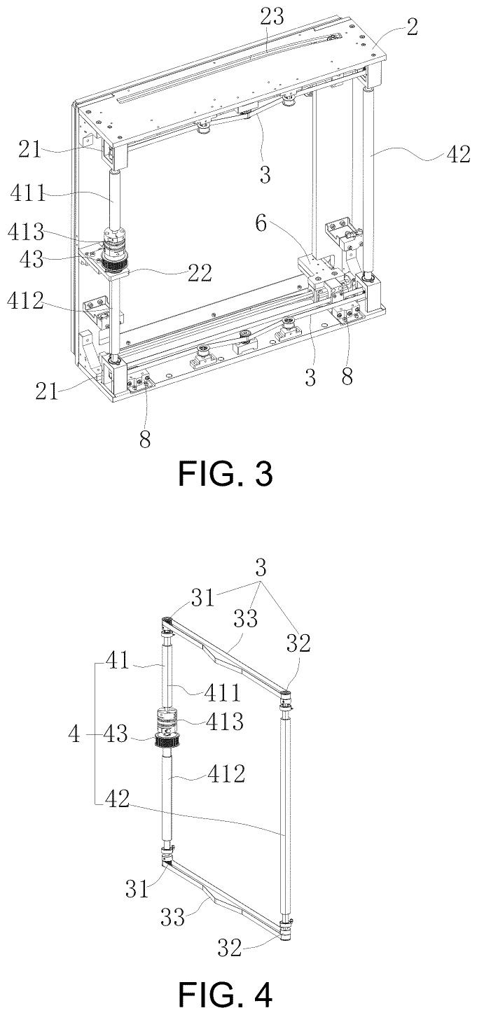

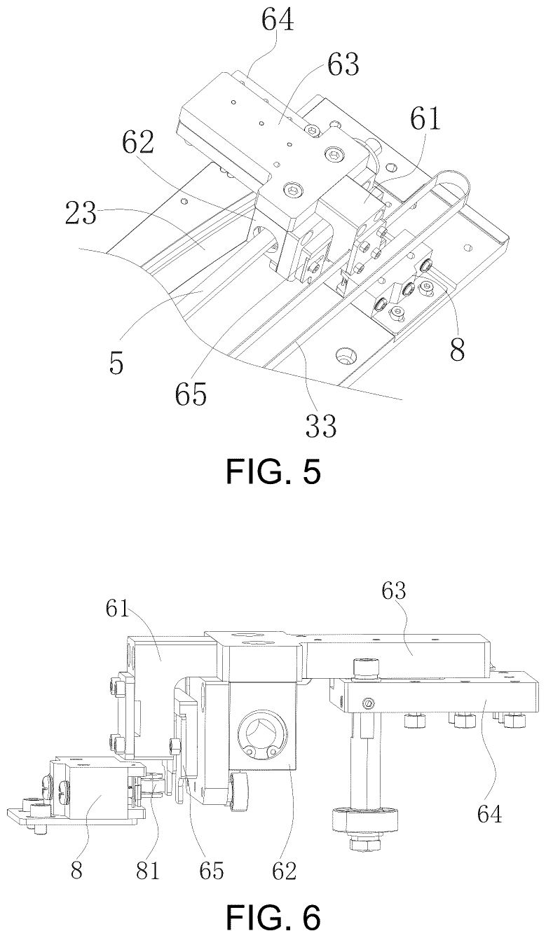

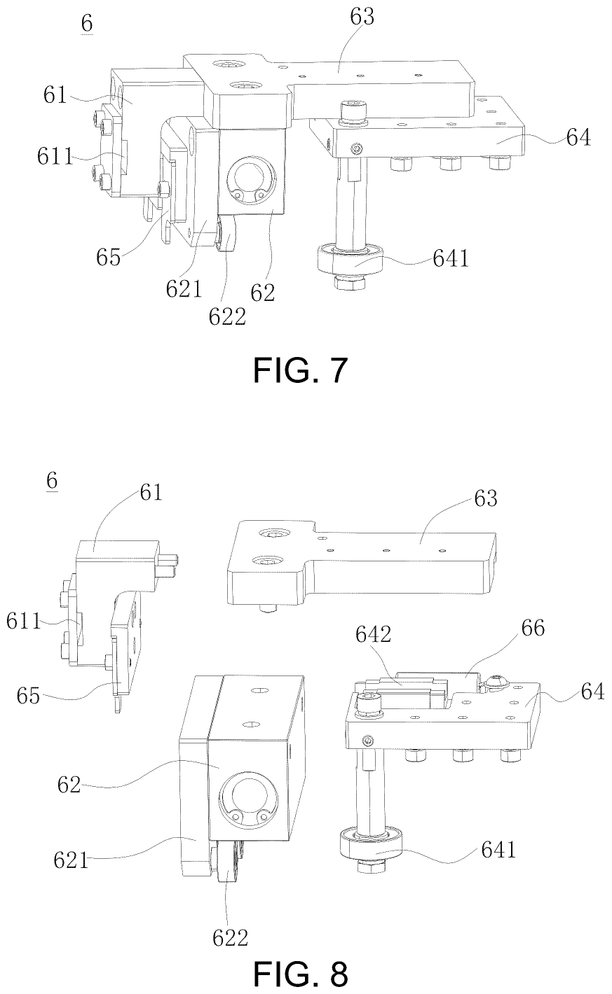

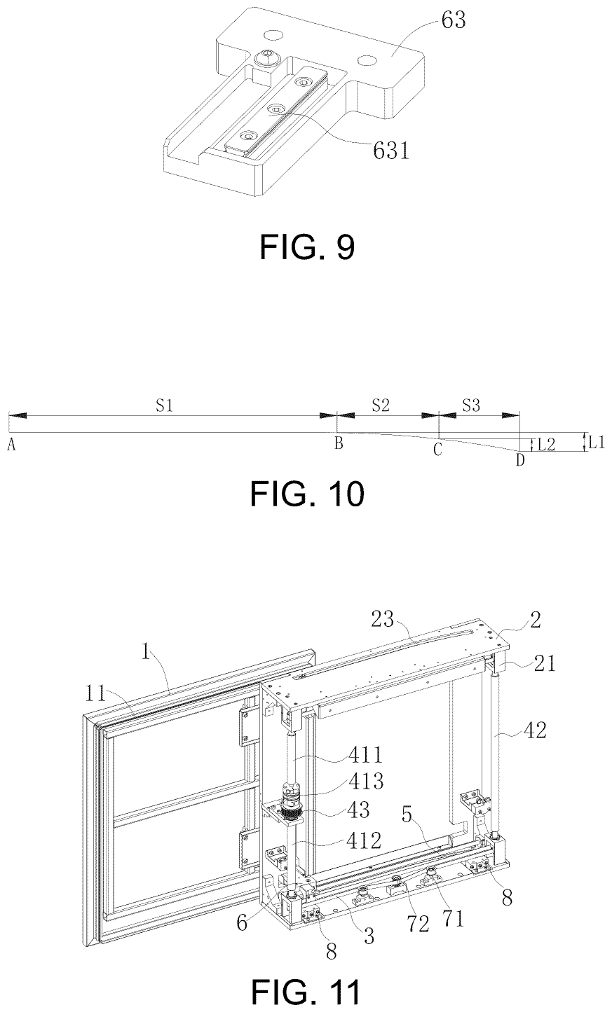

As shown in FIG. 1 to FIG. 11, this embodiment provides a side sliding door, including a door panel 1 and a door frame 2. A synchronous drive module 4 and a transmission assembly are assembled on the door frame 2. The transmission assembly includes two sets of synchronous tape modules 3. The two sets of synchronous tape modules 3 are arranged in parallel one above the other on the door frame 2. The synchronous drive module 4 drives the two sets of synchronous tape modules 3 to move synchronously. The two sets of synchronous tape modules 3 jointly drive the door panel 1 to perform a flat opening action in the horizontal direction.

The outer surface of the door panel 1 away from the door frame 2 is planar. A sealing strip 11 is assembled on the inner surface of the door panel 1 close to the door frame 2. When the door panel 1 is in a closed state, the sealing strip 11 may be embedded at the opening of the door frame 2, sealing with the door frame 2. The door frame 2 is in a frame shape, with an opening formed on the door frame 2. The transmission assembly and the synchronous drive module 4 are assembled on the door frame 2. The transmission assembly and the synchronous drive module 4 drive the door panel 1 to move horizontally to cover the opening of the door frame 2, achieving door closing. The transmission assembly and the synchronous drive module 4 drive the door panel 1 to move horizontally away from the opening of the door frame 2, achieving door opening.

The transmission assembly is assembled on the door frame 2. The transmission assembly includes two sets of synchronous tape modules 3. The two sets of synchronous tape modules 3 are arranged in parallel one above the other on the door frame 2. The synchronous tape modules 3 extend horizontally, with one set of synchronous tape module 3 located above the opening and one set of synchronous tape module 3 located below the opening. Each set of synchronous tape module 3 includes a driving belt wheel 31, a driven belt wheel 32, and a synchronous belt 33. The synchronous belt 33 is wound around the driving belt wheel 31 and the driven belt wheel 32.

As a preferred technical solution of this embodiment, in order to adjust the tension of the synchronous tape module 3, a tension assembly 7 is further disposed on the door frame 2. The tension assembly 7 includes a tension idler 71 and a tension belt wheel 72. There are two tension idlers 71, with the two tension idlers 71 set on two sides of the tension belt wheel 72 respectively. By adjusting the position of the tension idler 71, the tension degree of the synchronous belt 33 may be changed. There are two sets of tension assemblies 7, configured for the two sets of synchronous tape modules 3 respectively.

The synchronous drive module 4 is configured to drive the two sets of synchronous tape modules 3 to move synchronously. The synchronous drive module 4 includes a drive member, a driving shaft 41, and a driven shaft 42. Both the driving shaft 41 and the driven shaft 42 are rotatably and vertically assembled on the door frame 2. The two ends of the driving shaft 41 are connected to the two driving belt wheels 31, ensuring synchronous rotation of the two driving belt wheels 31. The two ends of the driven shaft 42 are connected to the two driven belt wheels 32, ensuring synchronous rotation of the two driven belt wheels 32. The drive member is configured to drive the driving shaft 41 to rotate.

As a preferred technical solution of this embodiment, in order to achieve the assembly of the driving shaft 41 and the driven shaft 42, bearing bases 21 are formed at the four corners of the door frame 2. The two ends of the driving shaft 41 and the driven shaft 42 is rotatably assembled on the bearing bases 21.

As a preferred technical solution of this embodiment, the drive member drives the driving shaft 41 to rotate from the middle portion of the driving shaft 41. Specifically, a transmission wheel 43 is assembled at the axial middle portion of the driving shaft 41. The drive member drives the transmission wheel 43 through a driving belt, thereby driving the driving shaft 41 to rotate.

As a preferred technical solution of this embodiment, the driving shaft 41 may be an integral structure or a split structure. In this embodiment, the driving shaft 41 is set as a split structure. The driving shaft 41 includes a first driving shaft 411 and a second driving shaft 412. The second driving shaft 412 is longer than the first driving shaft 411. Correspondingly, a mounting base 22 is disposed on the door frame 2 at the axial middle portion corresponding to the driving shaft 41. The first end of the first driving shaft 411 is rotatably assembled on the bearing base 21. The first end of the second driving shaft 412 is rotatably assembled on the bearing base 21. The second end of the second driving shaft 412 is rotatably assembled on the mounting base 22, with the end portion thereof protruding from the mounting base 22. The second end of the second driving shaft 412 is connected to the second end of the driving shaft 411 through a coupling 413. The transmission wheel 43 is assembled on the second driving shaft 412.

The synchronous tape module 3 is connected to the door panel 1 through a connecting assembly 6. There are two sets of connecting assemblies 6, corresponding to the two sets of synchronous tape modules 3. One end of the connecting assembly 6 is clamped on the synchronous belt 33, and the other end of the connecting assembly 6 is connected to the inner surface of the door panel 1. When the two sets of synchronous tape modules 3 move synchronously, the two sets of synchronous tape modules 3 may jointly drive the door panel 1 to move. In this embodiment, the connecting assembly 6 includes a first fixing base 61 and a second fixing base 63. A fixing hole 611 is formed on the first fixing base 61. The synchronous belt 33 passes through the fixing hole 611 and moves along with the first fixing base 61. The second fixing base 63 is fixedly connected to the first fixing base 61, and the second fixing base 63 is configured to connect the door panel 1.

As a preferred technical solution of this embodiment, in order to limit the movement direction of the connecting assembly 6 driven by the synchronous belt 33, guide rods 5 are also disposed on the door frame 2. The number of the guide rods 5 is two, and the two guide rods 5 are set close to the two sets of synchronous tape modules 3 respectively. The guide rods 5 are set parallel to the synchronous tape modules 3. The connecting assembly 6 moves along the guide rods 5, and the guide rods 5 serve to guide the movement direction of the connecting assembly 6. Correspondingly, the connecting assembly 6 further includes a linear bearing 62. The first fixing base 61 and the second fixing base 63 are fixedly connected to the linear bearings 62 respectively. The linear bearings 62 are assembled on the guide rods 5. When the two sets of synchronous tape modules 3 move synchronously, the two sets of synchronous tape modules 3 may drive two sets of connecting assemblies 6 to move synchronously along the guide rods 5. Preferably, a side panel 621 is also fixed on one side of the linear bearing 62. A roller 622 is rotatably assembled on the side panel 621. When the linear bearing 62 makes a linear motion along the guide rod 5, the roller 622 may roll along the panel surface of the door frame 2, serving as a support and increasing the structural strength.

As a preferred technical solution of this embodiment, in order to achieve the insertion of the door panel 1 into the opening of the door frame 2, the door panel 1 needs to move back and forth relative to the door frame 2. The door panel 1 is set to be slidably assembled on the second fixing base 63. The door panel 1 is slidably assembled on the second fixing base 63 through an adapter base 64. The sliding direction of the adapter base 64 relative to the second fixing base 63 is perpendicular to the extending direction of the guide rod 5. Specifically, a slider 642 is formed on the upper surface of the adapter base 64, and a slide rail 631 is formed on the lower surface of the second fixing base 63. The slider 642 and the slide rail 631 are in sliding fit, and the extending direction of the slide rail 631 is perpendicular to the extending direction of the guide rod 5. Preferably, a groove may be formed on the lower surface of the second fixing base 63, with the slide rail 631 assembled in the groove. The slider 642 extends into the groove and is in sliding fit with the slide rail 631. The setting of the groove may limit the sliding range of the adapter base 64 relative to the second fixing base 63.

As a preferred technical solution of this embodiment, in order to define the movement trajectory of the door panel 1, tracks 23 are further disposed on the upper and lower panels of the door frame 2. The two tracks 23 have the same shape. A sliding portion 641 is formed on the adapter base 64, and the sliding portion 641 may extend into the track 23 to guide the movement of the door panel 1. Preferably, the sliding portion 641 may be a bearing roller, and the bearing roller is assembled on the adapter base 64 through a connecting member. The outer circumferential surface of the bearing roller is in rolling fit with the wall surface of the track 23. The bearing roller is in a rolling state on the inner wall surface of the track, generating a small rolling friction force. Similarly, both the upper and lower rows of synchronous belt assemblies are designed with such an adapter base structure, so that the opening and closing movement of the door panel will be more stable and reliable.

In order to ensure that the sliding portion 641 always abuts against the inner wall surface of the track 23, an elastic member 66 is further disposed between the adapter base 64 and the second connecting base 63. The elastic member 66 provides a pulling force to the adapter base 64, causing the outer circumferential surface of the sliding portion 641 to tightly adhere to the inner wall surface of the track 23. The elastic member 66 may be, but is not limited to, a tension spring.

The shape of the inner wall surface of the track 23 is shown in FIG. 10. The S1 section between point A and point B is a straight line segment. When the sliding portion 641 slides along the S1 section, the door panel 1 is in a pulled-open state relative to the door frame 2, and the door panel 1 is in a translational stage. The S2+S3 sections between point B and point D are a curved segment. When the sliding portion 641 moves from point B to point D, the door panel 1 is in a state of being slowly closed. When the sliding portion 641 moves from point D to point B, the door panel 1 is in a state of being slowly opened. That is, when the sliding portion 641 slides along the S2 and S3 sections, the door panel 1 is in a translational+inward movement stage. The S3 section between point C and point D is the sealing strip compressing stage. Correspondingly, L1 is the total amount of inward movement, and L2 is the compression amount of the sealing strip. The S1 section between point A and point B is set parallel to the axis of the guide rod 5, and the S2+S3 sections between point B and point D bend towards the guide rod 5.

In order to detect whether the door panel 1 is opened or closed in place, position-limiting switches 8 are further disposed on the door frame 2. The number of the position-limiting switches 8 is at least two, with at least one position-limiting switch 8 configured to sense whether the door panel 1 is closed in place, and at least one position-limiting switch 8 configured to sense whether the door panel 1 is opened in place. In this embodiment, two position-limiting switches 8 are provided, with the two position-limiting switches 8 assembled at the horizontal ends of the door frame 2 respectively. The two sets of connecting assemblies 6 are fixed at the upper and lower ends of one horizontal side of the door panel 1. The position-limiting switches 8 determine whether the door panel 1 is closed in place by sensing the position of the connecting assembly 6. Specifically, a sensing member 65 is fixed on the first fixing base 61 of the connecting assembly 6. The position-limiting switch 8 determines the position of the connecting assembly 6 by detecting the position of the sensing member 65, and thereby determining whether the door panel 1 is closed in place.

As a preferred technical solution of this embodiment, a rolling wheel 81 is assembled at one end of the position-limiting switch 8 facing the connecting assembly 6. The rolling wheel 81 may be in rolling fit with the sensing member 65 to avoid damaging the structure.

The side sliding door of this embodiment may be configured for side charging equipment. The aforementioned side sliding door performs a flat opening action in the horizontal direction, occupying little space and not increasing the height of the equipment, which is conducive to achieving miniaturization of the equipment.

The above description, in conjunction with the accompanying drawings, provides a detailed explanation of the implementation methods of the present disclosure. However, the present disclosure is not limited to the aforementioned implementation methods. Within the knowledge range possessed by ordinary technicians in this field, various modifications may be made without departing from the spirit of the present disclosure.

1. A side sliding door, comprising:
a door panel;
a door frame;
a transmission assembly, the transmission assembly comprising two sets of synchronous tape modules, the two sets of synchronous tape modules being arranged in parallel one above the other on the door frame;
a synchronous drive module, the synchronous drive module driving the two sets of synchronous tape modules to move synchronously, a synchronous motion of the two sets of synchronous tape modules driving the door panel to perform a flat opening action in a horizontal direction.

2. The side sliding door according to claim 1, wherein the synchronous tape module comprises a driving belt wheel, a driven belt wheel and a synchronous belt, the synchronous drive module comprises a drive member, a driving shaft and a driven shaft, the driving shaft and the driven shaft are both rotatably assembled, two ends of the driving shaft are connected to two of the driving belt wheels respectively, two ends of the driven shaft are connected to two of the driven belt wheels respectively, and the drive member drives the driving shaft to rotate.

3. The side sliding door according to claim 2, wherein an axial middle portion of the driving shaft is assembled with a transmission wheel, the drive member drives the transmission wheel to rotate through a driving belt.

4. The side sliding door according to claim 3, further comprising a guide rod, wherein the guide rod is configured for the synchronous tape module, the guide rod is parallel to the synchronous tape module, the synchronous tape module is connected to the door panel through a connecting assembly, the connecting assembly moves along the guide rod when being driven by the synchronous tape module.

5. The side sliding door according to claim 4, wherein the connecting assembly comprises a first fixing base, a linear bearing and a second fixing base, the first fixing base moves with the synchronous belt, the first fixing base drives the linear bearing to move linearly along the guide rod, and the linear bearing drives the door panel to move through the second fixing base.

6. The side sliding door according to claim 5, wherein the door panel is slidably assembled on the second fixing base through an adapter base, a sliding direction of the adapter base relative to the second fixing base is perpendicular to an extending direction of the guide rod.

7. The side sliding door according to claim 6, wherein a track is formed on the door frame, the adapter base is formed with a sliding portion, the sliding portion extends into the track and moves along the track.

8. The side sliding door according to claim 7, wherein an elastic member is further disposed between the adapter base and the second fixing base, under an action of the elastic member, the sliding portion is able to maintain abutted against an inner wall surface of the track.

9. The side sliding door according to claim 7, wherein the inner wall surface of the track comprises a straight line segment and a curve segment, the straight line segment is parallel to an axis of the guide rod, and the curve segment bends towards the guide rod.

10. The side sliding door according to claim 2, further comprising a tension assembly, the tension assembly is configured for the synchronous tape module, and the tension assembly tensions the synchronous belt.

11. The side sliding door according to claim 8, wherein the inner wall surface of the track comprises a straight line segment and a curve segment, the straight line segment is parallel to an axis of the guide rod, and the curve segment bends towards the guide rod.
